(19) United States
(12) Patent Application Publication
(10) Pub. No.: US 2016/0131531 A1
(43) Pub. Date: May 12, 2016

(54) THERMAL TEST BENCH FOR THE RUB STRIP OF A PANTOGRAPH AND PROCESS FOR CORRESPONDING THERMAL TEST

(71) Applicant: Societe Nationale Des Chemins De Fer Francais SNCF, St Denis (FR)

(72) Inventors: Gerard Blanvillain, Veretz (FR); Gerard Auditeau, Clamart (FR)

(21) Appl. No.: 14/553,080

(22) Filed: Nov. 25, 2014

(30) Foreign Application Priority Data
Nov. 25, 2013 (FR) 1361583

(51) Int. Cl. G01J 5/02; G01N 25/00

(52) U.S. Cl. CPC G01J 5/0255; G01N 25/00

(57) ABSTRACT

The invention relates to a heat-testing rig for a pantograph wearing strip (10), comprising a housing (11) for receiving said wearing strip to be tested; current supply and return means (13, 14), characterised in that it comprises at least one tool (15, 16, 17, 18, 19) carrying at least one segment (20, 21) of a catenary contact wire which can be supplied with current by said supply means and can be brought into mechanical contact with an upper surface of said wearing strip (10) to be tested, so as to form a point, known as the hot point, where current passes between this wire segment and said wearing strip, and means for measuring the temperature of said wearing strip. The invention further relates to a corresponding heat-testing method.

### 1. TECHNICAL FIELD OF THE INVENTION

The invention relates to devices and methods for laboratory simulation of the heating of a pantograph wearing strip due to current passing through. In other words, the invention relates to heat-testing rigs for a pantograph wearing strip and to the corresponding test methods making use of test rigs of this type.

### 2. TECHNOLOGICAL BACKGROUND

It is known that a railway vehicle, such as a train, underground train or tram, comprises an electric engine supplied with current by means of a catenary which comprises vertical supports supporting a contact wire which extends above the railway rails on which the vehicle travels. The supports of the catenary are spaced a few tens of metres apart and support a carrier cable on which the contact wire is suspended by means of pendulums. A pantograph is further installed on the roof of the electric engine of the railway vehicle to collect the electric current travelling in the contact wire so as to supply the engine with electrical energy during the movement thereof on the rails. This pantograph typically comprises a hinged part carried on the roof of the engine and a collector bow or head for receiving the current of the catenary contact wire. The part of the bow in contact with the catenary contact wire is known as the “wearing strip” of the pantograph.

During the installation of a catenary, the contact wire is staggered at each pillar, to avoid the contact and friction point between the pantograph and the contact wire always being the same, for fear of bringing about premature aging of the pantograph bow. This is known as the zigzag of the catenary. Also, the wearing band of the pantograph bow causes the wire to slide as a function of the progression of the train, but also causes it to scan the wearing strip from right to left and back as a result of the stagger. This wearing strip is formed of a carbon or metal (copper and/or steel) material, depending on the railway network. This wearing strip has to be able to resist the wear due to friction and the wear due to heating due to current passing through.

It is therefore necessary to be able to test the heating of pantograph wearing strips before they are used on railway vehicles. Tests and measurements in real conditions require a complete vehicle to be put into operation and allowed to travel without disturbing the commercial service of the other trains. This is very expensive to implement, sometimes to find that the heating is too great and that another measurement cycle needs to be carried out using a different wearing strip.

There is therefore a real need to be able to test wearing strips in the laboratory, in conditions very close to the real use conditions.

A device for heat-testing wearing strips in the laboratory currently exists. This device is disclosed in particular in standard EN50405. A device of this type comprises a support for receiving the wearing strip to be tested, current supply plates which come to squeeze the side walls of the wearing strip to be tested, and means for supplying these plates with current.

A device of this type has a number of drawbacks, including the fact that the current passes through laterally, and not on the top of the wearing strip, as would occur in reality when the pantograph slides on the catenary contact wire. Further, a device of this type does not simulate the zigzag effect of the catenary contact wire on the wearing strip. Finally, a device of this type does not make it possible to test low-thickness wearing strips, such as the metal bands used for example in a large part of the French railway network, since it is very difficult to squeeze them with the supply plates.

### 3. OBJECTS OF THE INVENTION

The invention aims to overcome at least some of the drawbacks of the prior art heat-testing rig.

In particular, the invention also aims to provide, in at least one embodiment of the invention, a heat-testing rig for a wearing strip of a pantograph which makes it possible to measure the heating of this wearing strip due to a current passing though, it conditions close to reality.

The invention also aims to provide, in at least one embodiment, a test rig which makes it possible to reproduce as realistically as possible the contact between a catenary contact wire and the wearing strip.

The invention also aims to provide, in at least one embodiment of the invention, a test rig which makes it possible to isolate the effect of current passing through, excluding the friction and the disruptive effects thereof.

The invention also aims to provide, in at least one embodiment, a test rig which makes it possible to test all types of wearing strip, irrespective of the thicknesses, materials and sizes thereof.

The invention also aims to provide a heat-testing method for a pantograph wearing strip using a heat-testing rig according to the invention.

### 4. SUMMARY OF THE INVENTION

For this purpose, the invention relates to a heat-testing rig for a pantograph wearing strip comprising:
a housing for receiving said wearing strip to be tested,
current supply and return means.

A test rig according to the invention is characterised in that it comprises:
at least one tool carrying at least one segment of a catenary contact wire which can be supplied with current by said supply means and can be brought into mechanical contact with an upper surface of said wearing strip to be tested, so as to form a point, known as the hot point, where current passes between this wire segment and said wearing strip,
means for measuring the temperature of said wearing strip.

A test rig according to the invention thus makes it possible to reproduce and measure, in the laboratory, the temperature increase in a wearing strip due solely to the electric current passing through. The rig according to the invention comprises at least one tool provide with at least one segment of a catenary contact wire which can be brought into mechanical and electrical contact with the upper surface of the wearing strip to be tested. The contact reproduced in the laboratory is therefore in accordance with the contact observed in reality during the normal use of a pantograph equipped with a wearing strip. It is therefore possible to test a wearing strip in the laboratory under normal use conditions.

Further, a rig according to the invention comprises a housing for receiving a wearing strip. This receiving housing may be of any type, so as to be adaptable to different types of wearing strips to be tested. For example, the receiving housing may comprise a support interface for receiving a wearing strip. A rig according to the invention can therefore receive and test all types of wearing strips or bows, including in particular low-thickness metal strips. A rig according to the invention can receive a strip provided with an aluminium plate, on which the carbon or metal strip to be tested is mounted, or a strip alone without a support plate.

Advantageously, a rig according to the invention comprises at least two adjacent tools—preferably five tools—extending longitudinally along the wearing strip to be tested so as to be able to form at least two distinct successive hot points—preferably five hot points—along the wearing strip to be tested.

A rig in accordance with this variant thus makes it possible to create a plurality of successive (non-simultaneous) hot points for the passage of current along the wearing strip to be tested. Of course, in accordance with other variants, the rig may comprise more than five tools for creating more hot points. This plurality of tools makes it possible in particular to simulate the zigzag of the catenary by creating a plurality of hot points for the passage of current along the wearing strip.

A rig in accordance with this variant makes it possible to simulate the zigzag of the catenary whilst still not generating additional friction which might disrupt the heating measurements on the wearing strip. In other words, a rig in accordance with this variant makes it possible to reproduce the effect of the zigzag of the catenary on the wearing strip whilst isolating the effect of the passage of current and without inducing disruptive friction. Thus, a test rig in accordance with this variant does not produce any variation in the surface state of the tested strip by friction.

According to another variant of the invention, the rig comprises at least two tools, preferably five tools, carried by a curved tool support mounted to be movable in rotation about a shaft parallel to the transverse direction of said wearing strip to be tested, said shaft being movable in translation in the longitudinal direction of said strip.

A rig in accordance with this variant likewise makes it possible to simulate the zigzag of the catenary by creating a plurality of hot points for the passage of current along the wearing strip. The contact between a segment of a tool and the wearing strip is obtained by setting the tool support in rotation about the rotation shaft, in combination with the movement of said rotation shaft in translation in the longitudinal direction of the strip. Thus, the assembly formed by the support and the tools rolls on said wearing strip to be tested in such a way that the tools successively enter into contact with the wearing strip to be tested.

Advantageously, a rig in accordance with this variant comprises two lateral cheeks extending on either side of the tool support to guide the rotation of said tool support in a predetermined plane.

The lateral cheeks make it possible to keep the tool support in a predetermined plane during the movement thereof in translation and the rotation thereof about the rotation shaft thereof. Also, the trajectory of the tool support is well-defined.

Advantageously and according to the invention, the number of tools and the respective arrangements thereof are predetermined as a function of a use configuration of said wearing strip.

In other words, a rig according to the invention can be parameterised to obtain an amplitude of the zigzag movement corresponding to a real use configuration. The amplitude depends in particular on the number of tools and the respective spacings thereof. For example, if it is desired to simulate a configuration in which the amplitude of the zigzag is 400 mm, using tools equipped with two wire segments spaced apart by 40 mm, it is necessary to arrange five tools spaced apart successively by 50 mm.

Advantageously and according to the invention, at least one tool is movable between a position known as the raised position, where no wire segment of this tool is in mechanical contact with said wearing strip, and a position known as the contact position, where at least one wire segment of this tool—preferably every wire segment of this tool—is in mechanical contact with said wearing strip.

Advantageously, a rig in accordance with this variant of the invention comprises means for displacing at least one movable tool—preferably each movable tool—which are suitable for displacing this tool between said raised position and said contact position.

If the tools are carried by a curved support mounted in rotation about a rotation shaft, said shaft being movable in translation in the longitudinal direction of the strip, the movement means make it possible to pivot the curved support about the rotation shaft and to move said shaft, making it possible to bring the tools successively into contact with the wearing strip to be tested, making it possible to create a sequence of hot points along the wearing strip. A phenomenon of the tools rolling on the strip to be tested is observed.

If the tools extend longitudinally along the wearing strip, the movement means are for example formed by piston actuators, which make it possible to successively move the tools from the raised position to the contact position, thus creating a sequence of hot points along the wearing strip.

To create a hot point, it is necessary on the one hand for the tool to be moved in such a way that at least one wire segment of this tool is in contact with the wearing strip and on the other hand for this wire segment to be supplied with current.

Further, advantageously, a rig according to the invention comprises forcing means for at least one tool—preferably for each tool—suitable for causing at least one segment of this tool—preferably each segment—to exert a compressive force on said wearing strip to be tested.

A strip in accordance with this variant makes it possible to reproduce the stress exerted on the wire of a catenary by a pantograph. A rig in accordance with this variant thus makes it possible not only to isolate the effect of the passage of current, but also to simulate the force exerted on the wire of a catenary by a pantograph. A rig in accordance with this variant thus gives an accurate representation of reality. Further, a test rig in accordance with this variant makes it possible to control the contact stress, without crushing or excessively deforming the tested wearing strip.

Further, these forcing means can advantageously be parameterised to be able to adapt the levels of stresses exerted by the tools to the experimental results of the temperature measurements taken on the material in commercial service.

These forcing means may be of different types depending on the tools used.

For example, if the tools extend longitudinally along the wearing strip and are actuated by movement means, these movement means may act as forcing means. In other words, once the tool is in the contact position, the movement means are suitable for exerting a thrust force towards the wearing strip to simulate the force exerted on the catenary by the pantograph.

If the tools extend longitudinally along the wearing strip, but are held in a fixed position against the wearing strip, the forcing means may be mechanical means for controlled pressing of the tools against the wearing strip. They may equally be formed by parameterisable pre-stressed springs which exert a force against the wearing strip.

If the tools are carried on a curved support, advantageously, the forcing means are formed by a predetermined weight mounted on the rotation shaft of said tool support, which exerts a force towards said wearing strip to be tested.

Advantageously, a rig according to the invention, comprising forcing means, comprises a control system which manages said supply means and said forcing means, said system being configured to provide a current supply from said supply means to at least one wire segment of at least one tool—preferably each wire segment of each tool—which is gradual and is a function of the gradual variation in the stress exerted on the wear strip to be tested by this wire segment of this tool by means of said forcing means.

A rig in accordance with this variant thus makes it possible to transfer current from one tool to another gradually as a function of the gradual variation in the stress between the hot contact points.

According to another variant, the current supply to the wire segments is permanent, and it is the successive movements of the tools that form the successive hot points along the wearing strip.

Advantageously, the control system also manages the means for displacing the tools in such a way that the frequency of the hot points is controlled. This makes it possible to vary the speed of the zigzag movement of the simulated configuration.

Advantageously and according to the invention, at least one wire segment of a tool—preferably each wire segment of each tool—has a flat spot suitable for fitting tightly against the machined upper surface of said wearing strip to be tested.

According to this variant, a wire segment has a flat spot which is shaped and matched to the machining of the upper surface of the wearing strip, making it possible to reproduce the wearing effect of a wearing strip in contact with a catenary contact wire in normal conditions of use.

Advantageously and according to the invention, at least one tool—preferably each tool—comprises an insulating plate beneath which each segment of catenary contact wire is fixed by means of an interface plate, a jack comprising a cylinder and a piston, said piston being mounted on said insulating plate by means of a ball joint.

The ball joint makes it possible to ensure completely flat contact of each wire segment against the wearing strip.

The jack acts as movement means for the tool in the case of movable tools arranged longitudinally along the strip to be machined.

Preferably, in the case of tools carried on a curved support, the ball joint is directly linked to the curved support, and not to the jack, which is not of any great utility in this variant.

Advantageously and according to the invention, said means for measuring the temperature of said wearing strip comprise at least one heat camera suitable for measuring the temperature of said wearing strip at at least one hot point. Preferably, the means for measuring the temperature are suitable for measuring the temperature of said band at each hot point formed.

As a variant or in addition, the measurement means comprise at least one temperature gauge arranged directly within the wearing strip to be tested.

Advantageously and according to the invention, at least one tool—preferably each tool—comprises two segments of catenary contact wire arranged in parallel with one another. The presence of two parallel wire segments makes it possible to ensure completely flat contact of each wire segment on the strip.

Advantageously, a test rig according to the invention is equipped with a means for cooling said wearing strip to be tested by controlled ventilation. A controlled ventilation cooling means of this type makes it possible to simulate the movement of the vehicle. The level of ventilation depends on the speed of the vehicle to be simulated.

The invention also relates to a method for heat-testing a pantograph wearing strip making use of a heat-testing rig according to the invention.

A method according to the invention is characterised in that it comprises the steps of:
forming successive hot points by successively placing a plurality of adjacent tools in forced contact, between a first tool and a final tool and back, and maintaining each hot point for a predetermined period of time,
measuring the temperature of said wearing strip at each hot point formed,
repeating the cycle until stable temperatures or maximum allowable temperatures are reached.

A method according to the invention thus makes it possible to test a strip by forming successive hot points by successively manipulating the tools and by measuring the temperature of the different hot points formed. These temperature measurements are preferably permanent so as to take into account the thermal inertia of the tested wearing strip.

A test rig according to the invention and a method according to the invention may contribute to providing a particular number of results which are useful when designing a pantograph which is to equip a railway vehicle. They make it possible in particular to determine the temperature increase in a wearing strip at a predetermined current. They also make it possible to verify that the measured temperature does not exceed a limit set-point of the wearing strip as specified for example by a manufacturer. They also make it possible to evaluate the impact of the passage of current on the distribution of heat within the wearing strip and to determine the diffusion and cooling capacity thereof.

The invention also relates to a device and a method characterised in combination by some or all of the features mentioned above or below.

### 5. LIST OF DRAWINGS

Further aims, features and advantages of the invention will become apparent upon reading the following description, which is given purely by way of non-limiting example and refers to the accompanying drawings, in which:

FIG. 1 is a schematic front view of a heat-testing rig for a pantograph wearing strip in accordance with a first embodiment of the invention,

FIG. 2 is a schematic front view of a heat-testing rig in accordance with a second embodiment of the invention,

FIG. 3 is a schematic front view of a heat-testing rig in accordance with a third embodiment of the invention,

FIG. 4 is a schematic longitudinal section of a tool for a heat-testing rig in accordance with an embodiment of the invention,

FIG. 5 is a schematic cross-section of a wire segment of a tool in contact with a wearing strip of a heat-testing rig in accordance with an embodiment of the invention,

FIG. 6 is a schematic view of a method for heat-testing a pantograph wearing strip using a heat-testing rig in accordance with an embodiment of the invention.

### 6. DETAILED DESCRIPTION OF EMBODIMENTS OF THE INVENTION

For reasons of illustration and clarity, scales and proportions are not adhered to in the drawings. Throughout the following detailed description with reference to the drawings, unless stated otherwise, each element of the heat rig is described as it is arranged when the rig is horizontal and a wearing strip to be tested is placed horizontally in the test rig. This arrangement is shown in particular in FIGS. 1, 2 and 3.

A heat-testing rig for a pantograph wearing strip 10 according to the invention comprises a housing 11 for receiving the wearing strip 10 to be tested. This receiving housing 11 comprises for example two lateral supports 65, 66 on which the wearing strip 10 to be tested is placed. Of course, in other embodiments, the receiving housing may comprise other means for receiving and holding the wearing strip, such as clamps, claws or any equivalent means suitable for squeezing the band at each end thereof and holding it in position in the test rig. The rig may be used to test all types of wearing strip, irrespective of the size of the strip. Nevertheless, in general pantograph wear strips have a width of 35 to 60 mm.

In the embodiment in the drawings, the wearing strip 10 to be tested is associated with a support plate 12 which is arranged directly on the lateral supports 65, 66. The strip may be a strip made of copper and/or steel and/or carbon or any equivalent material.

The heat rig according to the invention also comprises supply means for the rig, comprising for example a supply plug 13 connected to a source of current (not shown in the drawings) and current return plug 14.

In a first embodiment, as shown in FIG. 1, the heat rig comprises five tools 15, 16, 17, 18, 19 arranged longitudinally along a shaft parallel to the wearing strip 10 to be tested. Throughout the description, the wearing strip is considered to extend along a direction known as the longitudinal direction. Each tool caries two segments 20, 21 of a catenary contact wire. Of course, in other embodiments, the rig may comprise more (or fewer) than five tools and each tool may comprise a single catenary contact wire (or more than two).

Throughout the following, only the tool 15 is disclosed in detail, it being understood that the other tools are identical in structure and functionality.

The tool 15 carries two segments 20, 21 of a catenary contact wire. The catenary wires represent the network on which the vehicle equipped with a pantograph provided with the tested wearing strip is intended to travel. For example, for a railway vehicle travelling on a French rail network, supplied with direct current, the wire is a copper wire having a section of 107 mm². Preferably, the length of each wire segment 20, 21 is selected in such a way that it is of a size slightly greater than the width of the wearing strip to be tested.

As is shown in FIG. 4, each wire segment 20, 21 is fixed, for example by soldering, to an interface plate 22, the interface plate 22 itself being fixed beneath an insulating plate 23. The wire segments 20, 21 are spaced apart from one another by a distance of between 25 and 60 mm, for example 40 mm. The distance between the two segments is selected as a function of the features of the railway network on which the tested wearing strip 10 is intended to be used.

The insulating plate 23 is preferably a rigid plate formed from an epoxy material. It has for example dimensions of 50×60 mm² and a thickness of 10 to 20 mm. The insulating plate 23 is linked to a jack 24 formed of a cylinder 25 and a piston 26 which can slide inside the cylinder 25. The piston 26 of the jack 24 is linked to the insulating plate 23 by means of a ball joint 27, giving the tool 15 freedom of movement in a horizontal plane and thus making possible flat contact of the two segments 20, 21 of the tool 15 on the upper surface of the wearing strip 10 to be tested.

Preferably, each wire segment 20, 21 has a flat spot 28 formed by machining. The wearing strip 10 to be tested is also machined to provide perfect flatness and controlled roughness, for example less than 0.8 μm.

The combination of machining the wire segments 20, 21 and machining the wearing strip to be tested makes it possible to guarantee perfect contact between the tool 15 and the wearing strip.

In the embodiment of FIG. 1, each tool is movable between a raised position, where no wire segment 20, 21 of this tool is in mechanical contact with said wearing strip 10, and a contact position, where the wire segments 20, 21 of this tool are in mechanical contact with the wearing strip. In FIG. 1, the tool 18 is in the contact position whilst the tools 15, 16, 17 and 19 are in the raised position.

The transition from the raised position to the contact position is provided by the action of the actuating jacks of the tools, which form movement means for the tools. Preferably, these jacks are pneumatic jacks actuated by a pneumatic control unit 30. In another embodiment, these jacks are hydraulic, actuated by a hydraulic or electric control unit.

The pneumatic control unit 30 is configured to drive the movement of the tools in a cycle, so as to be able to drive each tool into the contact position in a cycle. Further, the control unit 30 is configured in such a way that each tool, once in the contact position, exerts a predetermined compressive force on the wearing strip, thus forming forcing means for each tool. This compressive force makes it possible to simulate controlled contact between a pantograph equipped with a wearing strip and a catenary line.

In parallel with the movement of the tools and with the stress exerted on each tool, an electric control unit 31 is configured to manage the electric supply means in such a way that they supply the segments of the tool in contact with the wearing strip so as to form a hot point where current passes between the segments and the wearing strip 10. Electric wires 62 arranged between the electric supply means and the interface plates 22 make it possible to convey the current, at the command of the electric control unit 31, to the segments of each tool. This electric command unit 31 is for example formed of a plurality of contactors and an electric control card.

The pneumatic control unit 30 and the electric control unit 31 form a control system 32.

This control system 32 is configured to supply the wire segments 20, 21 of each tool with current gradually and as a function of the gradual variation in the stress exerted by this tool on the wearing strip to be tested.

The control principle of the control system 32 is shown in FIG. 6.

Each line A, B, C, D and E represents the variations in position of a respective tool 15, 16, 17, 18 and 19.

The tools are normally in the raised position, in other words not in contact with the wearing strip 10 to be tested.

The tool 15 is lowered by a command to move the tool 15 from the raised position to the contact position (the command line passes from a state 1, corresponding to the raised position, to a state 0, corresponding to the contact position). The tool is kept in the contact position for a predetermined period of time. During this period of time, the jack exerts a compressive force on the wearing strip 10. Further, the electric control unit 31 causes a hot point to be formed by the supply of current to the wire segments of this tool 15.

The adjacent tool 16 is subsequently lowered by a command to move the tool 16. Once the tool 16 reaches the contact position thereof, the stress exerted by the tool 15 on the wearing strip is reduced in portion to that exerted on the wearing strip by the tool 16. Further, the current supply to the tool 16 is naturally proportional to the stress exerted by this tool 16. Also, the tool 16 will gradually take on the entire current supply and be the only tool to exert a compressive force on the wearing strip. The hot point for the passage of current will therefore be moved gradually from the tool 15 to the tool 16. As is shown in the drawings, the tools 15 and 16 are in contact with the wearing strip simultaneously for a predetermined period of time.

The same operations are repeated until the last tool 19.

When the last tool 19 has formed the corresponding hot point thereof, the operations are repeated in the reverse direction, forming the hot point of the tool 18, then of the tool 17, and so on until the hot point of the first tool 15 is formed.

This cycle of forming the hot points by activating the tools 15 to 19, then in reverse from 19 to 15, is repeated until the measured temperature is stable or reaches a predetermined limit value.

The segments of the tools may be supplied with current permanently or as a function of the position of the tool (in other words only being supplied when the tool is in the contact position). If the supply is permanent, the wire segments are supplied permanently in such a way that only the ascent/descent cycles of each tool are managed by the control system and determine the formation of a hot point.

In the context of the embodiment of FIG. 1, the permanent supply to the tools is simpler to provide and does not require a complex electric control unit.

The control system 32 is programmed in such a way that the time between two descents of a single tool corresponds to the time taken by a catenary to carry out a zigzag corresponding to the real configuration of a predetermined train at a predetermined speed. These parameters vary for each network and each type of vehicle. For example, for railway vehicles travelling on the French network and supplied with voltages of 25 kV, a cycle is carried out in 2 s at a speed of 220 km/h and the amplitude of the zigzag is 400 mm. If the supply is direct current, the observed zigzag is completed in 8 s. In Germany, the amplitude observed is 600 mm.

A test rig according to the invention makes it possible to test all configurations by parameterising the control system and adapting the number of tools and the respective arrangements thereof.

It is possible for example to simulate a network which merely comprises a single catenary contact wire by replacing a wire segment of a test rig in accordance with the embodiment of FIG. 1 with an insulator or by disconnecting one wire segment of each tool. It is likewise possible to adjust the distance between two tools and/or to increase the number of tools in the test rig to obtain a test rig which reproduces the specific conditions of use of the tested wearing strip.

The temperature measurement of the hot points formed in the tested wearing strip 10 is obtained for example using a heat camera arranged facing the wearing strip. The temperature may also be measured using temperature gauges arranged in and/or under the wearing strip.

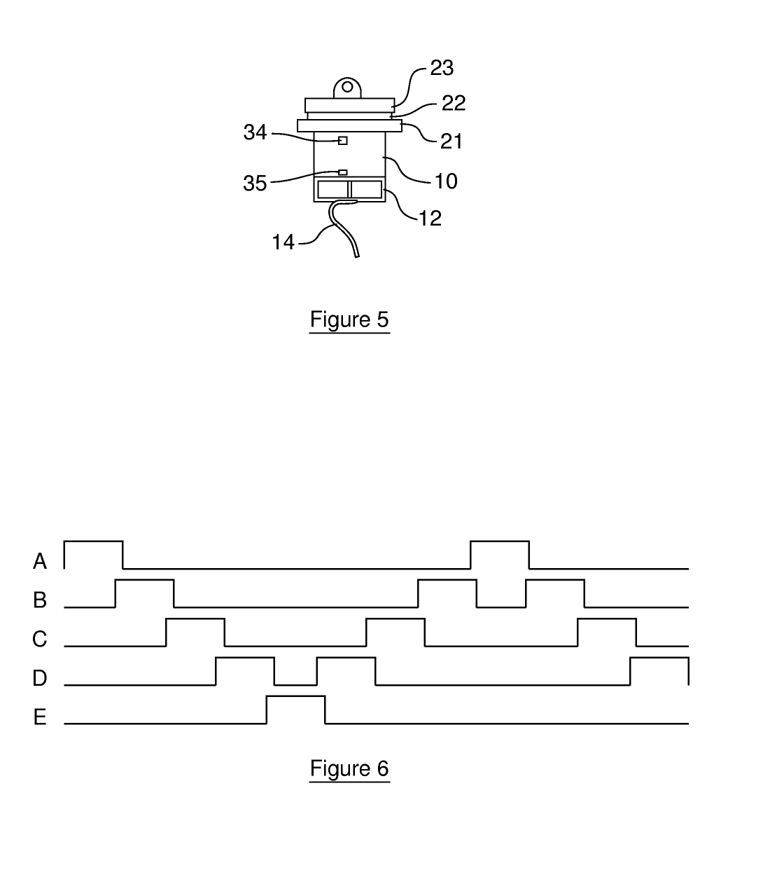

For example, FIG. 5 is a section of a wearing strip 10, in which temperature gauges 34, 35 have been arranged. These temperature gauges may be of any known type. The temperature measurements are recovered by a processing unit and analysed. This processing unit makes it possible to determine whether the test cycles need to be continued or whether new cycles need to be carried out.

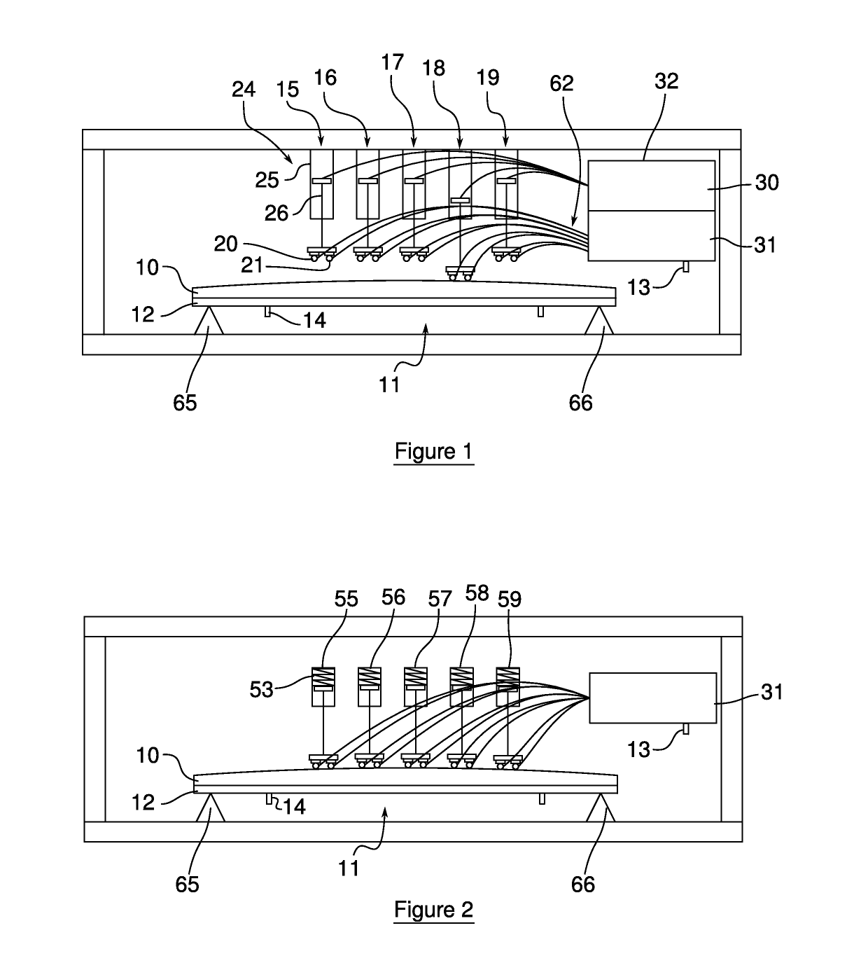

In a second embodiment, as shown in FIG. 2, the test rig comprises tools 55, 56, 57, 58 and 59 which are mounted fixed with respect to the wearing strip 10 to be tested. In other words, the tools are no longer movable between a raised position and a contact position, but they are consistently in the contact position. Each tool may be of a structure identical to that disclosed in connection with the first embodiment of FIG. 1.

The operation of the rig is thus identical to that disclosed in connection with the first embodiment, except that the actuation of the jacks of each tool is merely used to exert a stress force of each tool against the wearing strip to be tested.

Further, the supply of the tools cannot be permanent, and it is precisely by supplying the tools successively that the successive hot points can be formed along the wearing strip. The electric controller is configured to supply each tool successively. In other words, by comparison with the embodiment of FIG. 1, the sequence of movements of the tools is replaced with the sequence of the tools being supplied by the control unit. This current supply may be gradual, from one tool to an adjacent tool, or may be an abrupt supply, one tool suddenly changing from a supplied state to a non-supplied state and the adjacent tool suddenly changing from a non-supplied state to a supplied state. The gradual movement of the hot point along the wearing strip is thus obtained by way of the simultaneous contact, during a predetermined period of time, of the two adjacent tools, as disclosed in connection with FIG. 6.

In the embodiment of FIG. 2, the tools are pre-stressed against the wearing strip. In particular, each tool comprises an eccentric spring for exerting a predetermined stress on the wearing strip by means of a mechanical piston.

In another embodiment (not shown), each tool may no longer comprise a jack and be fixed to the wearing strip by screw-nut or clamp means. The pressing of each tool determines the stress on the wearing strip from the tool.

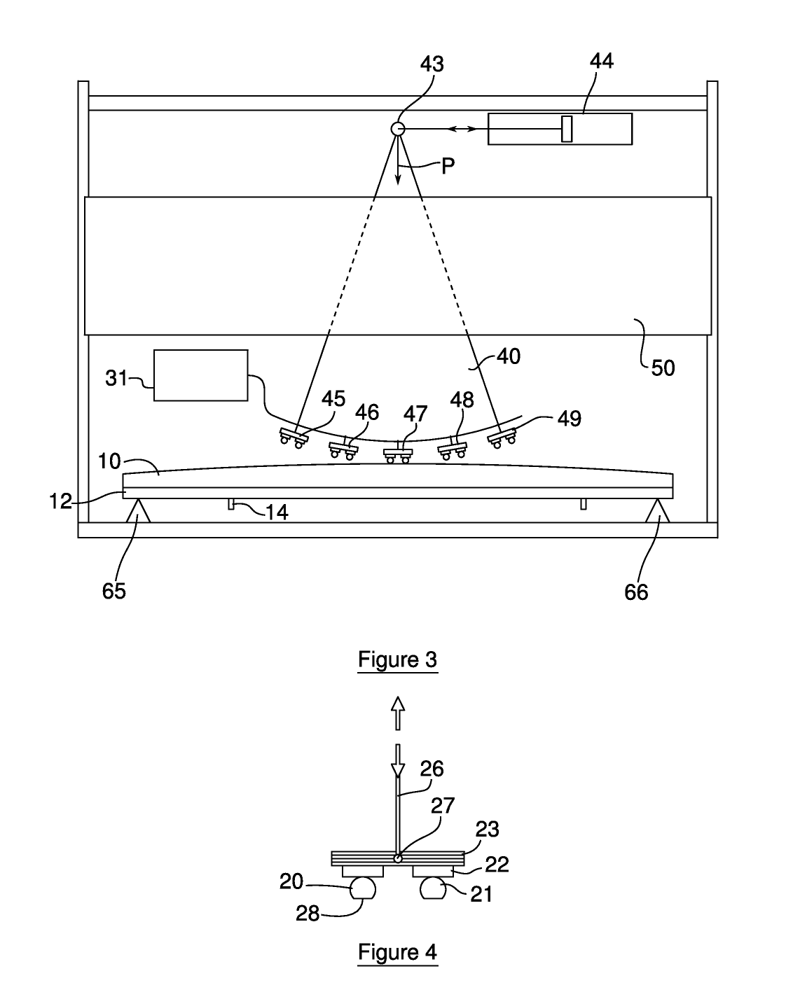

In a third embodiment, as shown in FIG. 3, the heat rig comprises a curved tool support 40, which carries tools 45, 46, 47, 48, 49 which are arranged along the curve of the support 40. Each tool may have a structure identical to that disclosed in connection with the first or the second embodiment disclosed above. Nevertheless, preferably each tool 45, 46, 47, 48 and 49 does not comprise a dedicated jack, and so the insulating plate of each tool is fixed directly to the curved support 40.

This support 40 is mounted pivotably about a shaft 43 which is driven in translation by a single piston actuator 44 which forms the movement means for the tools. This actuator is managed by the control system 32. The rolling movement of the support 40 is guided by two parallel lateral cheeks 50 which extend on either side of the wearing strip to be tested and make it possible to keep the support on a trajectory parallel to the axis of the wearing strip 10.

The support 40 being set in rotation, as a result of the shaft 43 being set in translation, makes it possible to move each tool from a position where it is not in contact with the wearing strip to a position where it is in contact with the wearing strip 10. In other words, by comparison with the first embodiment, the movement of the tools by way of individual jacks for each tool in the first embodiment is replaced with rolling of the curved support 40 by way of a single actuator.

The forcing means are formed by a weight denoted schematically by the letter P in FIG. 3. This weight P exerts a compressive force from each tool on the wearing strip, once it is in the contact position. This weight P makes it possible to make the stress progress as a function of the movement of the support 40.

The electric supply by way of the control unit 31 of the wire segments is substantially identical to that disclosed in connection with FIG. 1. It may thus be permanent or successive.

The invention is not limited merely to the disclosed embodiments. In particular, a test rig according to the invention may comprise two receiving housings so as to be able to test the wearing strips of a pantograph which comprises two strips and of which the support armature cannot be disassembled. The principle is substantially identical to that disclosed, comprising two strips arranged side by side in the test rig and a plurality of tools arranged opposite each of the wearing strips to be tested.

1. Heat-testing rig for a pantograph wearing strip (10), comprising:
a housing (11) for receiving said wearing strip (10) to be tested,
current supply and return means (13, 14).
characterised in that it comprises:
at least two adjacent tools (15, 16, 17, 18, 19; 55, 56, 57, 58, 59; 45, 46, 47, 48, 49) extending longitudinally along the wearing strip to be tested, each tool carrying at least one segment (20, 21) of a catenary contact wire which can be supplied with current by said supply means and can be brought into mechanical contact with an upper surface of said wearing strip (10) to be tested, so as to form a point, known as the hot point, where current passes between this wire segment (20, 21) and said wearing strip (10), said tools forming at least two distinct successive hot points along the wearing strip to be tested,
means (34, 35) for measuring the temperature of said wearing strip (10).

2. Test rig according to claim 1, characterised in that it comprises at least two tools (45, 46, 47, 48, 49) carried by a curved tool support (40) mounted to be movable in rotation about a shaft (43) parallel to the transverse direction of said wearing strip (10) to be tested, said shaft (43) being movable in translation along the longitudinal direction of said strip.

3. Test rig according to either claim 1 or claim 2, characterised in that the number of tools and the respective arrangements thereof are predetermined as a function of a use configuration of said wearing strip (10).

4. Test rig according to any of claims 1 to 3, characterised in that at least one tool (15, 16, 17, 18, 19; 45, 46, 47, 48, 49) is movable between a position known as the raised position, where no wire segment of this tool is in mechanical contact with said wearing strip (10), and a position known as the contact position, where at least one wire segment (20, 21) of this tool is in mechanical contact with said wearing strip.

5. Test rig according to claim 4, characterised in that it comprises means (25, 26; 44) for moving at least one movable tool (15, 16, 17, 18, 19; 45, 46, 47, 48, 49) which are suitable for moving this tool between said raised position and said contact position.

6. Test rig according to any of claims 1 to 5, characterised in that it comprises forcing means (25, 26; 53; P) for at least one tool suitable for causing at least one segment (20, 21) of this tool to exert a compressive force on said wearing strip (10) to be tested.

7. Test rig according to claims 2 and 6 combined, characterised in that said forcing means (P) are formed by a predetermined weight mounted on the rotation shaft (43) of said tool support (40), which exerts a force towards said wearing strip to be tested.

8. Test rig according to either claim 6 or claim 7, characterised in that it comprises a control system (32) which manages said supply means and said forcing means, said system (32) being configured to provide a current supply from said supply means to at least one wire segment (20, 21) of at least one tool, which is gradual and is a function of the gradual variation in the stress exerted on the wear strip to be tested by this wire segment (20, 21) of this tool by means of said forcing means.

9. Test rig according to any of claims 1 to 8, characterised in that at least one wire segment (20, 21) of a tool has a flat spot (28) suitable for fitting tightly against the machined upper surface of said wearing strip (10) to be tested.

10. Test rig according to any of claims 1 to 9, characterised in that at least one tool comprises an insulating plate (23) beneath which each segment (20, 21) of catenary contact wire is fixed by means of an interface plate (22), a jack (24) comprising a cylinder (25) and a piston (26), said piston (26) being mounted on said insulating plate (23) by means of a ball joint (27).

11. Test rig according to any of claims 1 to 10, characterised in that said means for measuring the temperature of said wearing strip comprise at least one heat camera suitable for measuring the temperature of said wearing strip at at least one hot point.

12. Test rig according to any of claims 1 to 11, characterised in that at least one tool comprises two segments (20, 21) of catenary contact wire arranged in parallel with one another.

13. Method for heat-testing a pantograph wearing strip (10) using a heat-testing rig according to any of claims 1 to 12, characterised in that it comprises the steps of:
forming successive hot points by placing a plurality of adjacent tools successively in forced contact, between a first tool and a final tool and back, and maintaining each hot point for a predetermined period of time,
measuring the temperature of said wearing strip at each hot point formed,
repeating the cycle until stable temperatures or maximum allowable temperatures are reached.
